(19) United States
(12) Patent Application Publication
(10) Pub. No.: US 2012/0264843 A1
(43) Pub. Date: Oct. 18, 2012

(54) COMPOSITION CONTAINING SPECIFIC CARBAMATE TYPE COMPOUNDS SUITABLE FOR PRODUCING POLYURETHANE FOAMS

(75) Inventor: Martin Glos, Borken (DE)

(73) Assignee: EVONIK GOLDSCHMIDT GMBH, Essen (DE)

(21) Appl. No.: 13/447,772

(22) Filed: Apr. 16, 2012

(30) Foreign Application Priority Data
Apr. 15, 2011 (DE) DE102011007468.6

(51) Int. Cl. C08G 71/04

(52) U.S. Cl. 521/154; 521/189

(57) ABSTRACT

Compositions suitable for producing polyurethane foams which include at least an isocyanate component, a polyol component, a catalyst catalyzing formation of a urethane or isocyanurate bond, and at least one compound containing at least one structural element of formula (I)

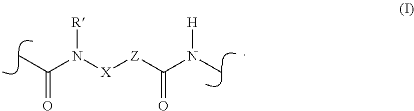

### FIELD OF THE INVENTION

The present invention relates to compositions suitable for producing polyurethane foams which include at least an isocyanate component, a polyol component, a catalyst catalyzing the formation of a urethane or isocyanurate bond, optionally a blowing agent and further additives. The compositions of the present invention additionally include at least one compound containing at least one structural element of formula (I)

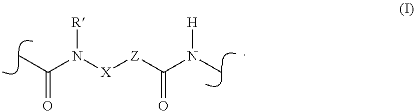

The present invention also relates to a process for producing foamed polyurethane or polyisocyanurate materials using these compositions and also the use of the corresponding foamed polyurethane or polyisocyanurate materials.

### BACKGROUND

The production of foams based on polyols and isocyanates utilizes cell-stabilizing additives to ensure a uniform and low-defect foam structure and hence to exert a substantially positive influence on the performance characteristics of the foamed material. Surfactants based on organically modified siloxanes are particularly effective and therefore represent the preferred type of foam stabilizer.

When organically modified siloxanes are added in the course of the foaming process, the organically modified siloxanes are often not only in pure form but in the form of admixtures with further non-silicon-containing components. This can serve to improve meterability, since the amounts of siloxane to be added to the mixture to be foamed are often only very small. In addition, the admixed component can also improve the solubility of siloxanes in the polyol mixture and hence additionally influence the foaming process and the foam properties.

It can be advantageous for the admixed component to also have surfactant properties that exert a positive influence on the foam properties. Recent demand has been more and more frequently for polyurethane foams that do not include any siloxane foam stabilizers.

Various foam stabilizers and/or admixture components are known from the prior art:

EP 0839852 A2 describes the production of polyurethane foam using siloxanes in admixtures with vegetable oils consisting of different triglycerides. The vegetable oils however do not appear to have any influence on foam quality.

German Applications DE 1802500 and DE 1802503 describe alkanolamides obtained for example by reaction of diethanolamine with natural fatty acids or naturally occurring glycerides, and their use as a polyol component in the production of polyurethane foams. The description mentions the possibility that the use of siloxane surfactants can be dispensed with.

Similarly, German Applications DE 1745443, and DE 1745459 as well as U.S. Pat. No. 3,578,612 describe alkanolamides of polymeric fatty acids or alkoxylates thereof which can be used as a polyol component for producing polyurethane foams. The foaming process disclosed in the aforementioned prior art always includes a siloxane stabilizer.

U.S. Pat. No. 3,629,308 describes butanol-started polyethers useful as an admix component for organosiloxanes.

EP 48984 B1 describes admixtures of siloxanes with various water-soluble surfactants for use in a polyester-polyurethane foam. These surfactants are often poorly biodegradable.

EP 43110 A1 describes admixtures of siloxanes with solvents such as, for example, alkoxylates onto glycerol, water, TMP, butanol or nonylphenol for use in a high-resilience polyurethane foam.

U.S. Pat. No. 5,236,961 describes the production of polyurethane foams using alkylphenol ethoxylates as foam stabilizers. The alkylphenol ethoxylates disclosed in US '961 originate from petrochemical sources.

EP 0734404 describes the production of polyurethane (PU) foams using polyalkylene oxides, wherein the polyalkylene oxides are constructed using 10-90% of butylene oxide.

DE 2244350 describes the use of copolymers prepared from N-vinylpyrrolidone and maleic esters for producing polyurethane foams.

Many of the foam stabilizers described in the prior art, more particularly those based on silicon, and/or their admixed components, are notable for unfavorable toxicity, poor biodegradability or sensitivity to hydrolysis.

The non-Si-containing stabilizers known according to the prior art are only obtainable at relatively high cost and inconvenience, are usually not based on renewable resources, and have poor biodegradability.

### SUMMARY

The present invention produces foams based on polyols and isocyanates using compositions that do not have one or more of the disadvantages known from the prior art.

The present invention accordingly provides compositions suitable for producing polyurethane foams which include at least an isocyanate component, a polyol component, a catalyst catalyzing the formation of a urethane or isocyanurate bond, optionally a blowing agent and optionally further additives, which compositions further include a compound containing at least one structural element of formula (I).

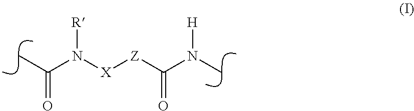

wherein R′, X and Z will be defined in greater detail herein below.

The present invention also provides a process for producing foamed polyurethane materials by reaction of a composition according to the invention, and also foamed polyurethane materials containing at least one compound including at least one structural element of formula (I).

The present invention further provides for the use of foamed polyurethane materials according to the invention as or for producing insulating materials, preferably insulating panels, refrigerators, insulating foams, vehicle seats, more particularly auto seats, roof liners, mattresses, filtering foams, packaging foams or spray foams, and refrigerating apparatuses including a foamed polyurethane material according to the invention as an insulating material.

The compounds of the present invention have the advantage that their use makes it possible to dispense with the use of Si-containing foam stabilizers completely or at least partially.

A further advantage of the use of the compounds of the present invention is that their use makes it possible to achieve reduced emissions.

The compounds used according to the invention also have the advantage that the inventive compounds lead to a better solubility of pentane, a widely used blowing agent, as a result of which more blowing agent can be added to the corresponding compositions.

A further advantage of the use of the compounds of the present invention is that they can be largely based on renewable resources.

The compounds of the present invention further have the advantage that they can be used alone or in admixture with silicon compounds that include carbon atoms, in many different types of foam, for example in rigid foams, hot-cure flexible foams, viscoelastic foams, ester foams, HR foams and semi-rigid foams, as foam stabilizers.

### DETAILED DESCRIPTION OF THE INVENTION

The present invention will now be described by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present invention, their content shall fully belong to the disclosure content of the present invention particularly in respect of the factual position in the context of which the document was cited. Percentages are by weight, unless otherwise stated. Average values indicated in what follows are weight averages, unless otherwise stated.

Polyurethane foam (PU foam) refers in the context of the present invention to a foam obtained as a reaction product based on isocyanates and polyols or compounds having isocyanate-reactive groups. In the course of the reaction to form the eponymous polyurethane, further functional groups can also be formed, examples are allophanates, biurets, ureas or isocyanurates. Therefore, PU foams within the meaning of the present invention include not only polyurethane foams (PUR foams) but also polyisocyanurate foams (PIR foams).

The composition of the present invention, which is suitable for producing polyurethane foams, includes at least a polyol component, a catalyst catalyzing the formation of a urethane or isocyanurate bond, optionally a blowing agent, optionally further additives and optionally an isocyanate component, and a compound containing at least one structural element of formula (I).

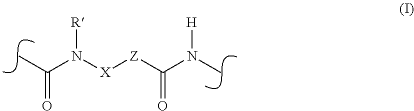

where R′ in each occurrence is the same or different and represents H or an organic radical, more particularly C₁-C₁₂ alkyl, aryl, alkylaryl radical which may optionally include oxygen or nitrogen atoms, more particularly hydroxyl or amino groups, or a radical of formula (II).

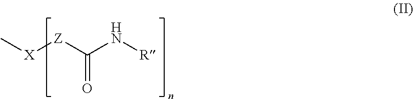

n=1 to 5 (depending on the functionality of X), preferably 1,
X in each occurrence is the same or different and represents an organic radical having at least two carbon atoms, preferably an optionally substituted ethylene, propylene or isopropylene unit,
Z in each occurrence is the same or different and represents O or NR″′ where R″′ is H or alkyl, preferably H, and
R″ in each occurrence is the same or different and represents an organic radical, preferably a hydrocarbon radical, which may be, for example, saturated or unsaturated and/or branched or unbranched and which, given appropriate functionality, can also link two or more structural elements of formula I together (the org. radical R″ can thus include further linking groups obtainable from isocyanate groups).

Preferably, the composition of the present invention includes as a compound containing at least one structural element of formula (I), hereinafter referred to as inventive compound, a compound of formula (III)

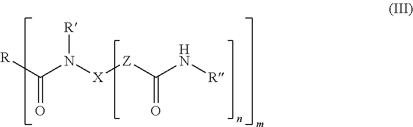

where n, X, Z, R′ and R″ are each as defined above, m=1 to 5, preferably 1, 2 or 3 and R is an organic radical, preferably a hydrocarbon radical.

More preferably, the composition of the present invention contains as an inventive compound a compound of formula (IV)

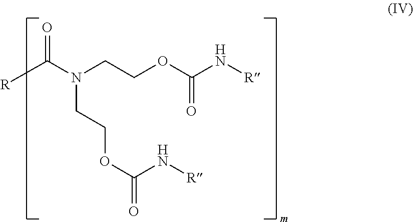

where m, R and R″ are each as defined above, preferably m=1, 2 or 3 and R=hydrocarbon radical having 1 to 30 carbon atoms, preferably having 8 to 20 carbon atoms when m=1 and 1 to 7, preferably 2 to 6 carbon atoms when m=2 or 3, preferably 3, or of formula (IVa)

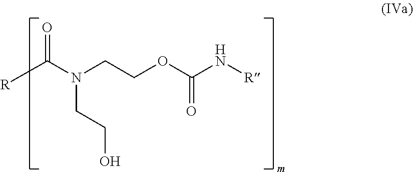

or, when m=1 and R″ includes a functionality of p, a compound of formula (IVb)

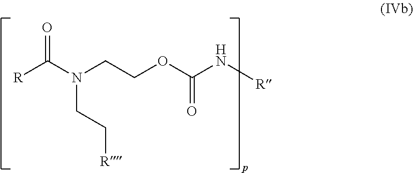

where R″″=—OH or —OC(O)—NH—R″ and p=1 to 10, preferably 2 to 6, and more preferably a compound of formula (IVc)

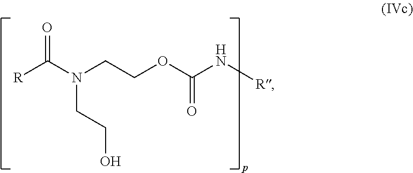

where, in formulae (IV) to (IVc) m, R and R″ are each as defined above.

The inventive compound of formula (IVc) is a particularly preferred variant based on fatty acids and isocyanates having a functionality of above 1.

An inventive compound of formula (IV) can be prepared using diethanolamine for example.

The proportion of compounds containing at least one structural element of formula (I) (inventive compounds) is preferably in the range from 0.1 to 10 parts by mass, more preferably in the range from 0.5 to 5 parts by mass and even more preferably in the range from 1 to 3 parts by mass, based on 100 parts by mass of polyol components.

Suitable inventive compounds can be obtained by reacting alkanolamides or amide-amines, preferably fatty acid alkanolamides or fatty acid amide-amines, with isocyanates.

This preparation can take place in a multistage operation by reaction of carboxylic acids or carboxylic acid derivatives, preferably fatty acids or fatty acid glycerides, with OH-functional amines or diamines and subsequent reaction of the OH- or NH-functional acid amide with isocyanates.

The acid amides can be obtained according to processes known in the prior art, see, for example, DE 1802500, DE 1802503, DE 1745443, DE 1745459 and U.S. Pat. No. 3,578,612. The corresponding carboxylic acids can be used in the present disclosure as raw materials, for example, and amide formation can take place by detachment of water. Carboxylic esters, such as methyl esters for example, can similarly be used, in which case methanol is then detached. In one embodiment, it is particularly preferable to use glycerides of naturally occurring fats and oils because the glycerol formed in the course of the amidation can remain in the reaction mixture. Similarly, when triglycerides are reacted with amines, for example, di- and monoglycerides can additionally be present in the reaction mixture provided the reaction conditions were chosen appropriately. When carboxylic esters are used, corresponding catalysts such as alkoxides, for example, are optionally used to provide an amidation at relatively mild conditions compared with the abovementioned detachment of water. When higher-functional amines (DETA, AEEA, TRIS) are used, the preparation of the amides may also lead to the formation of corresponding cyclic amides such as imidazolines or oxazolines.

When a basic catalyst is used in the amidation, it can be advantageous to perform a subsequent neutralization with an appropriate amount of organic or inorganic acid. Suitable compounds are known to a person skilled in the art.

In some embodiments, it is particularly preferable for the amides formed by basic catalysis to be neutralized with organic anhydrides of dicarboxylic acids, since the neutralized amines are able to react with the available OH- or NH-functions and thereby converted in a bonded state, and thus, later in the final foam, cannot be emitted in the form of free carboxylic acids. Moreover, when alkali metal alkoxides are used, for example, corresponding esters are then formed in the neutralization, and so the free alcohols cannot escape from the system.

Preferred organic anhydrides are cyclic anhydrides such as, for example, succinic anhydride, maleic anhydride, alkylsuccinic anhydrides, such as dodecylsuccinic anhydride or polyisobutylenesuccinic anhydride, similarly suitable are adducts of maleic anhydride onto corresponding polyolefins such as, for example, polybutadienes, copolymers of maleic anhydride and olefins, styrene-maleic anhydride copolymers, vinyl ether-maleic anhydride copolymers, and also generally copolymers which contain maleic anhydride as a monomer, phthalic anhydride, benzophenonetetracarboxylic dianhydride, pyromellitic dianhydride, itaconic anhydride or similar structures. Examples of commercially available anhydrides of this type are, e.g., the Poylvest® types from Evonik Degussa GmbH or Ricon® MA types from Sartomer.

The reaction of the amides with isocyanates can be carried out according to familiar processes. Any catalyst which can also be used for producing polyurethane foams can be used here for example. The catalysts are, for example, tertiary amines or metal catalysts based on titanium, tin, zinc, bismuth or zirconium.

All the reaction steps can be carried out without a solvent or suitable solvents can be used. When solvents are used, the active content can be in the range from 10 to 99% preferably 20 to 98% and more preferably 30 to 97%.

Carboxylic Acids:

Monocarboxylic acids, dicarboxylic acids, tricarboxylic acids, tetracarboxylic acids based on aliphatic or aromatic hydrocarbons or derivatives thereof can be used to prepare the inventive compounds.

Examples of alkyl radicals for monocarboxylic acids are: methyl, ethyl, propyl, butyl, pentyl, hexyl, heptyl, octyl, nonyl or decyl, and the like, the preference here is for 2-ethylhexanoic acid, nonanoic acid, and isononanoic acid.

Examples of alkenyl groups include: ethenyl, propenyl, butenyl, pentenyl, hexenyl, heptenyl, octenyl, nonenyl, decenyl and the like.

Examples of aromatic acids include: aryl and alkylaryl (alkylaryl is defined as an aryl-substituted alkyl or arylalkyl group), such as for example: phenyl, alkyl-substituted phenyl, naphthyl, alkyl-substituted naphthyl, tolyl, benzyl, dimethylphenyl, trimethylphenyl, phenylethyl, phenylpropyl, phenylbutyl, propyl-2-phenylethyl, salicyl and the like.

Aromatic dicarboxylic acids that can be employed include, for example: isophthalic acid, terephthalic acid or phthalic acid. Illustrative of useful aliphatic dicarboxylic acids are: succinic acid, malonic acid, adipic acid, dodecanedicarboxylic acid, maleic acid, fumaric acid, itaconic acid, citraconic acid, mesaconic acid, tartaric acid, malic acid, malonic acid, glutaric acid, adipic acid, pimelic acid, suberic acid, azelaic acid, sebacic acid, and citric acid.

Illustrative useful higher-functional acids are: trimesic acid, pyromellitic acid, and benzophenonetetracarboxylic acid.

Preferred acids are straight-chain saturated or unsaturated fatty acids having up to 40 carbon atoms such as, for example, butyric acid (butanoic acid), caproic acid (hexanoic acid), caprylic acid (octanoic acid), capric acid (decanoic acid), lauric acid (dodecanoic acid), myristic acid (tetradecanoic acid), palmitic acid (hexadecanoic acid), stearic acid (octadecanoic acid), arachidic acid (eicosanoic acid), behenic acid (docosanoic acid), linoceric acid (tetracosanoic acid), palmitoleic acid ((Z)-9-hexadecenoic acid), oleic acid ((Z)-9-hexadecenoic acid), elaidic acid ((E)-9-octadecenoic acid), cis-vaccinic acid ((Z)-11-octadecenoic acid), linoleic acid ((9Z,12Z)-9,12-octadecadienoic acid), alpha-linolenic acid ((9Z,12Z,15Z)-9,12,15-octadecatrienoic acid), gamma-linolenic acid ((6Z,9Z,12Z)-6,9,12-octadecatrienoic acid), di-homo-gamma-linolenic acid ((8Z,11Z,14Z)-8,11,14-eicosatrienoic acid), arachidonic acid ((5Z,8Z,11Z,14Z)-5,8,11,14-eicosatetraenoic acid), erucic acid ((Z)-13-docosenoic acid), nervonic acid ((Z)-15-tetracosenoic acid), ricinoleic acid, hydroxystearic acid and undecenylic acid, and also mixtures thereof, for example rapeseed oil acid, soya fatty acid, sunflower fatty acid, peanut fatty acid and tall oil fatty acid. It is further possible to use dimer and oligomeric fatty acids as formed in the oligomerization of unsaturated fatty acids.

Sources of suitable fatty acids or fatty acid esters particularly glycerides can be vegetable or animal fats, oils or waxes. There can be used for example: dripping, beef tallow, goose fat, duck fat, chicken fat, horse fat, whale oil, fish oil, palm oil, olive oil, avocado oil, seed kernel oils, coconut oil, palm kernel oil, cocoa butter, cottonseed oil, pumpkin seed oil, maize germ oil, sunflower oil, wheat germ oil, grape seed oil, sesame oil, linseed oil, soya bean oil, peanut oil, lupene oil, rapeseed oil, mustard oil, castor oil, jetropa oil, walnut oil, jojoba oil, lecithin e.g. based on soya, rapeseed or sunflowers, bone oil, neat's-foot oil, borage oil, lanolin, emu oil, deer tallow, marmoset oil, mink oil, borage oil, thistle oil, hemp oil, pumpkin oil, evening primrose oil, tall oil, and also carnauba wax, bees wax, candellila wax, ouricury wax, sugar cane wax, retamol wax, caranday wax, raffia wax, esparto wax, alfalfa wax, bamboo wax, hemp wax, Douglas fir wax, cork wax, sisal wax, flax wax, cotton wax, dammar wax, tea wax, coffee wax, rice wax, oleander wax, bees wax or wool wax.

Amines having additional hydroxyl or amine functionality:

Amines are suitable that have at least one primary or secondary amine function for amidating and an isocyanate-reactive group such as, for example a hydroxyl or amine function. Depending on the amine used, the production process, i.e., the amidation, has to be controlled such that the product still contains at least one isocyanate-reactive group.

Suitable amines are for example: ethylenediamine, diethylenetriamine (DETA), triethylenetetramine (TETA), tetraethylenepentamine (TEPA), dipropylenetriamine, tripropylenetetramine, tetrapropylenepentamine, pentapropylenehexamine, hexapropyleneheptamine, and also higher homologs based on ethylenediamine or propylenediamine, 1,2-propylenediamine, 4,4′-diaminodicyclohexylmethane, 3,3′-dimethyl-4,4′-diaminodicyclohexylmethane, 4,4-methylenediphenylenediamine, isophoronediamine, trimethylhexylmethylenediamine, neopentanediamine, octamethylenediamine, polyether-amines such as Polyetheramin D 2000 (BASF), Polyetheramin D 230 (BASF), Polyetheramin T 403 (BASF), Polyetheramin T 5000 (BASF) or else corresponding Jeffamine types from Huntsman, piperazine, aminoethylpiperazine, bis(aminoethyl)piperazine, 1,3-diaminopropane, 3-(cyclohexylamino)propylamine, 3-(methylamino)propylamine, N,N-bis(3-aminopropyl)methylamine, (3-(2-aminoethylamino)propylamine), and dipropylenetriamine, (N,N′-bis(3-aminopropyl)ethylenediamine.

Suitable hydroxylamines having at least one OH function are for example: ethanolamine, propanolamine, alkylethanolamines, arylethanolamine, alkylpropanolamine, for example: diethanolamine, monoethanolamine, diisopropanolamine, isopropanolamine, methylisopropanolamine, digylcolamine (2-(2-aminoethoxy)ethanol), dimethylethanolamine, N-(2-hydroxyethyl)aniline, 1-(2-hydroxyethyl)piperazine, 2-(2-aminoethoxy)ethanol, 3-amino-1-propanol, 5-amino-1-pentanol, butylethanolamine, ethylethanolamine, N-methyl-ethanolamine, aminopropylmonomethylethanolamine, 2-amino-2-methylpropanol, trishydroxymethylaminomethane (THMAM or TRIS), N-(2-aminoethyl)ethanolamine (AEEA). It is also possible to use corresponding alkoxylates, more particularly ethoxylates and/or propoxylates of amines, for example alkylamines having a hydroxyethyl or hydroxypropyl unit or, for example, N-hydroxyethylcyclohexyldiamine, N-hydroxethylisophoronediamine, N-hydroxyethylpiperazine, and bis(hydroxyethyl)toluenediamine.

However, the inventive compound can also be prepared using appropriate commercially available amides having OH or NH functions, for example from Evonik Goldschmid: Rewomid® DC 212 S, Rewomid® DO 280 SE, Rewocid® DU 185 SE, Rewolub® KSM, REWOMID® C 212, REWOMID® IPP 240, REWOMID® SPA, Rewopon® IM AO, Rewopon® IM AN or Rewopon® IM R 40 and also DREWPLAST® 154, NINOL® 1301, NINOL® 40-CO, NINOL® 1281, NINOL® COMF, NINOL® M-10 and ethoxylated diethanolamides such as NINOL® C-4 1, NINOL® C-5, NINOL® 1301 from Stepan or DACAMID® MAL and DACAMID® DC from Sasol.

Isocyanates:

Aromatic and aliphatic isocyanates are also suitable for preparing the inventive compound. The aromatic and aliphatic isocyanates can be mono-, di-, tri- or higher-functional. Modified isocyanates can also be used, examples are carbodiimides, uretdiones, urethanes, isocyanurates, ureas, biurets, allophanates, and also pre-polymers obtainable by crosslinking or partial conversion of the isocyanate groups.

Isocyanate pre-polymers have a higher molar mass and can have improved solubility in the reaction mixture than the underlying isocyanates.

Examples of suitable isocyanates are:

toluenyl diisocyanate (TDI), which is frequently manufactured and used as an isomeric mixture of 2,6- and 2,4-toluenyl diisocyanate, and methylenediphenyl diisocyanate (MDI), which is frequently manufactured and used as an isomeric mixture of 4,4-, 2,4- and 2,2-methylenediphenyl diisocyanate. The use of polymeric MDI, also known as crude MDI, is similarly customary. Concerned here are mixtures of higher average functionality, consisting of polynuclear MDI components, 1,5-naphthylene diisocyanate, p-phenylene diisocyanate, 3,3′-dimethylbiphenyl-4,4′-diyl diisocyanate, tris(isocyanatophenyl)methane, 1,3-bis(1-isocyanato-1-methylethyl)benzene, phenyl isocyanate, m-tolyl isocyanate, o-tolyl isocyanate, p-tolyl isocyanate, 1-naphthyl isocyanate, 3-chlorophenyl isocyanate, 4-chlorophenyl isocyanate, 3-chloro-4-tolyl isocyanate, 2,4-dichlorophenyl isocyanate, 3,4-dichlorophenyl isocyanate, 3,5-dichlorophenyl isocyanate, p-isopropylphenyl isocyanate, 2,6-diiso-propylphenyl isocyanate, ∝,∝,∝-trifluoro-3-tolyl isocyanate, p-(trifluoromethoxy)phenyl isocyanate or p-toluenesulphonyl isocyanate.

Examples of suitable aliphatic isocyanates are:

hexamethylene diisocyanate, isophorone diisocyanate, 1,1-methylenebis(4-iso-cyanatocyclohexane), 1,3-bis(isocyanatomethyl)benzene, bis(isocyanatomethyl)-bicyclo[2.2.1]heptanes, 2-heptyl-3,4-bis(9-isocyanatononyl)-1-pentylcyclohexane, 1,3-bis(1-isocyanato-1-methylethyl)benzene, 1,6-diisocyanato-2,2,4-trimethylhexane, 1,6-diisocyanato-2,4,4-trimethylhexane, 1,4-diisocyanatocyclohexane, 1,3-bis(isocyanatomethyl)cyclohexane, methyl isocyanate, ethyl isocyanate, isopropyl isocyanate, n-butyl isocyanate, hexadecyl isocyanate, octadecyl isocyanate (stearyl isocyanate) or cyclohexyl isocyanate.

It is similarly possible to use appropriate derivatives of the isocyanates mentioned, for example uretdiones, carbodiimides, isocyanurates or else pre-polymers.

Commercially available isocyanates are for example: Desmodur® types from Bayer, Vestanant types from Evonik Degussa or Suprasec® types from Huntsman such as: Desmodur® 44V20, Desmodur® 44V70L, Desmodur® 44M, Desmodur® VP PU 129, Desmodur® CD-S, Desmodur® T 80, Desmodur® N3300, Vestanat® IPDI, Vestanat® T 1890/100, Vestanat® TMDI, Vestanat® H12MDI, Vestanat® HB 2640/100, Vestanat® HT 2500 L, Suprasec® 2085, Suprasec® 1100, or Suprasec® 2020.

It can be advantageous for the composition of the present invention to contain silicon compounds which include one or more carbon atoms and which are preferably selected from polysiloxanes, organomodified polysiloxanes, polyether-modified polysiloxanes and polyether-polysiloxane copolymers.

As silicon compounds including one or more carbon atoms there may be used the substances mentioned in the prior art. Preference is given to using such silicon compounds which are suitable for the particular foam types (rigid foams, hot-cure flexible foams, viscoelastic foams, ester foams, HR foams, semi-rigid foams). Suitable siloxanes are described for example in the following documents: EP 0839852, EP 1544235, DE 10 2004 001 408, WO 2005/118668, U.S. Patent Application Publication 20070072951, DE 2533074, EP 1537159, EP 533202, U.S. Pat. No. 3,933,695, EP 0780414, DE 4239054, DE 4229402, and EP 867465. The silicon compounds can be prepared as described in the prior art. Suitable examples are described for example in U.S. Pat. No. 4,147,847, EP 0493836 and U.S. Pat. No. 4,855,379.

Particularly preferred silicon compounds have formula (V),

R¹—Si(CH₃)₂—O—[—Si(CH₃)₂—O—]ₐ—[—Si(CH₃)R²—O—]_{b}—Si(CH₃)₂—R³ (V)

where
R² in each occurrence the same or different=—(CH₂)ₓ—O—(CH₂—CHR⁴—O)_{y}—R⁵ or a C₈ to C₂₂ alkyl radical,
R¹ and R³ the same or different=—CH₃ or R², provided at least one R¹ or R³ radical is equal to R²,
a+b+2=10 to 150, preferably 25 to 120,
b=0 to 25, preferably 0.5 to 15,
x=3 to 10, preferably 3,
y=1 to 30, preferably 5 to 25,
R⁴ in each occurrence the same or different=H, —CH₃, —CH₂CH₃ or phenyl,
R⁵ in each occurrence the same or different=H, alkyl or acyl, preferably H, CH₃ or COCH₃.

In some embodiments, it can be advantageous for at least 50 mol % of the R⁴ radicals in the siloxane compounds of formula (V) to be H and preferably for at least 90 mol % of the R⁴ radicals in the siloxane compounds of formula V to be H. In other embodiments, it can also be advantageous for at least 5 mol % of the R⁴ radicals in the siloxane compounds of formula (V) to be methyl and preferably for at least 10 mol % of the R⁴ radicals of the siloxane compounds of formula (V) to be methyl. Preference is given to using such siloxane compounds of formula (V) wherein at least 50 mol % of the R⁴ radicals=H and wherein at least 10 mol % of the R⁴ radicals=methyl. It is more preferable to use such siloxane compounds of formula (V) wherein at least 90 mol % of the R⁴ radicals=H and at least 5 mol % of the R⁴ radicals=methyl.

Particular preference is given to such siloxane compounds of formula (V) wherein at least 5 mol % of the R⁵ radicals=alkyl or acyl radicals, preferably CH₃ or COCH₃ radicals and more preferably methyl radicals.

In some embodiments, it can be advantageous for the siloxane compounds of formula (IV) to contain the preferred R⁴ and R⁵ radicals in the mole percent ranges indicated above.

In particularly preferred siloxane compounds of formula (V), the a/b ratio is above 7, preferably above 8 and more preferably above 10.

In some embodiments of the present invention, it can be advantageous for at least 10 equivalence % (and at most 50 equivalence %) of the R² radicals in the siloxane compounds of formula (V) to be alkyl groups having 8 to 22 carbon atoms (based on the total number of R² radicals in the siloxane compound).

The mass ratio of silicon compounds to compounds containing at least one structural element of formula (I) is preferably in the range from 0.01:1 to 1:0.01, more preferably in the range from 0.05:1 to 1:0.05, even more preferably in the range from 0.1:1 to 1:0.1 and yet even more preferably in the range from 0.2:1 to 1:0.75.

The inventive compositions (for foam production) preferably include from 0.05 to 10 parts by mass of silicon compounds per 100 parts by mass of polyol components.

In some embodiments of the present invention, it can be advantageous for the inventive compounds to be used as solvents in the process for preparing the silicon compounds to be used in the composition, which is usually a hydrosilylation process. In this way, an additional separating step and/or the introduction of unwanted solvents into the compositions of the present invention is avoided.

By way of isocyanate component, the composition according to the invention may include any isocyanate compound suitable for producing polyurethane foams, more particularly rigid polyurethane or polyisocyanurate foams. Preferably the composition according to the invention includes one or more organic isocyanates having two or more isocyanate functions. A suitable isocyanate for the purposes of this invention is any polyfunctional organic isocyanate, for example 4,4′-diphenylmethane diisocyanate (MDI), toluene diisocyanate (TDI), hexamethylene diisocyanate (HMDI) and isophorone diisocyanate (IPDI). Of particular suitability is the mixture of MDI and more highly condensed analogs having an average functionality of 2 to 4 which is known as “polymeric MDI” (“crude MDI”). Examples of suitable isocyanates are mentioned in EP 1 712 578 A1, EP 1 161 474, WO 058383 A1, U.S. Patent Application Publication No. 2007/0072951 A1, EP 1 678 232 A2 and WO 2005/085310.

A suitable polyol for the purposes of this invention is any organic substance having two or more isocyanate-reactive groups and also any preparation thereof. Any polyether polyol or polyester polyol customarily used for producing polyurethane foams is preferred. Polyether polyols are obtained by reacting polyhydric alcohols or polyfunctional amines with alkylene oxides. Polyester polyols are based on esters of polybasic carboxylic acids (usually phthalic acid or terephthalic acid) with polyhydric alcohols (usually glycols). Polyols commensurate to the stipulated properties of the foams are used, as described for example in: U.S. Patent Application Publication No. 2007/0072951 A1, WO 2007/111828 A2, U.S. Patent Application Publication No. 2007/0238800, U.S. Pat. No. 6,359,022 B1 or WO 96 12759 A2. Similarly, vegetable oil-based polyols which are preferably usable are described in various patent documents, for example in WO 2006/094227, WO 2004/096882, U.S. Patent Application Publication No. 2002/0103091, WO 2006/116456 and EP 1 678 232.

The ratio of isocyanate to polyol, known as the index, is preferably in the range from 80 to 500 and more preferably in the range from 100 to 350 in the composition of the present invention. The index in effect describes the ratio of isocyanate actually used (for a stoichiometric reaction with polyol) to computed isocyanate. An index of 100 represents a molar ratio of 1:1 for the reactive groups.

By way of catalyst catalyzing the formation of a urethane isocyanurate bond, the composition of the present invention preferably includes one or more catalysts suitable for the reactions of isocyanate-polyol and/or isocyanate-water and/or isocyanate trimerization. Suitable catalysts for the purposes of this invention are preferably catalysts catalyzing the gel reaction (isocyanate-polyol), the blowing reaction (isocyanate-water) and/or the di- or trimerization of the isocyanate. Examples of suitable catalysts are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethylaminoethoxyethanol and bis(dimethylaminoethyl)ether, tin compounds such as dibutyltin dilaurate and potassium salts such as potassium acetate and potassium 2-ethylhexanoate. Suitable catalysts are mentioned for example in EP 1985642, EP 1985644, EP 1977825, U.S. Patent Application Publication No. 2008/0234402, EP 0656382 B1, and U.S. Patent Application Publication No. 2007/0282026 A1 and the patent documents cited therein.

Preferred catalyst quantities in the composition of the present invention depend on the type of catalyst and typically range from 0.05 to 5 pphp (=parts by mass per 100 parts by mass of polyol) or from 0.1 to 10 pphp for potassium salts.

By way of optional blowing agent, the composition of the present invention may include water or some other chemical or physical blowing agent. When water is used as blowing agent, suitable water contents for the purposes of this invention depend on whether or not one or more blowing agents are used in addition to the water. In the case of purely water-blown foams, the water contents are typically in the range from 1 to 20 pphp; when other blowing agents are used in addition, the use quantity is typically reduced to the range from 0.1 to 5 pphp. In some embodiments of the present invention, it is also possible to use a composition according to the invention that is completely free of water.

When blowing agents other than water are present in the composition of the present invention, these blowing agents other than water can be physical or chemical blowing agents. Preferably, the composition includes physical blowing agents. Suitable physical blowing agents for the purposes of this invention are gases, for example liquefied CO₂, and volatile liquids, for example hydrocarbons having 4 to 5 carbon atoms, preferably cyclopentane, isopentane and n-pentane, hydrofluorocarbons, preferably HFC 245fa, HFC 134a and HFC 365mfc, hydrochlorofluorocarbons, preferably HCFC 141b, hydrofluoroolefins, oxygen-containing compounds such as methyl formate and dimethoxymethane, or hydrochlorocarbons, preferably 1,2-dichloroethane.

In addition to or in place of water and any physical blowing agent, it is also possible to use chemical blowing agents which react with isocyanates to evolve a gas, such as formic acid for example.

By way of additives, the compositions of the present invention may include further additives useful in the production of polyurethane foams. Flame retardants for example are frequently used additives.

The composition of the present invention may include any known flame retardant suitable for production of polyurethane foams. Suitable flame retardants for the purposes of this invention are preferably liquid organic phosphorus compounds, such as halogen-free organic phosphates, e.g., triethyl phosphate (TEP), halogenated phosphates, e.g. tris(1-chloro-2-propyl) phosphate (TCPP) and tris(2-chloroethyl) phosphate (TCEP) and organic phosphonates, e.g., dimethyl methanephosphonate (DMMP), dimethyl propanephosphonate (DMPP), or solids such as ammonium polyphosphate (APP) and red phosphorus. Useful flame retardants further include halogenated compounds, for example halogenated polyols, and also solids, such as expandable graphite and melamine.

By way of further additives, the composition may optionally also contain further components known according to the prior art, for example polyethers, nonylphenol ethoxylates, or nonionic surfactants.

The compositions of the present invention are useful for producing PU foams.

The inventive process for producing polyurethane foams is characterized in that compositions according to the present invention are reacted.

In accordance with the requirements of the foam to be stabilized, the inventive composition used includes by way of foam stabilizer either the inventive compound alone or a combination of inventive compound with a silicon compound including one or more carbon atoms.

The present invention process for producing PU foams can be carried out according to familiar methods, for example by manual mixing or preferably by means of foaming machines. When the process is carried out using foaming machines, high-pressure or low-pressure machines can be used. The process of the present invention can be carried out as both a batch operation and as a continuous operation.

A comprehensive review of the prior art, of the raw materials which can be used and of the processes which can be used is given in G. Oertel (ed.): “Kunststoffhandbuch”, Volume VII, C. Hanser Verlag, Munich, 1983, in Houben-Weyl: “Methoden der organischen Chemie”, Volume E20, Thieme Verlag, Stuttgart 1987,(3), pages 1561 to 1757, and in “Ullmann's Encyclopedia of Industrial Chemistry” Vol. A21, VCH, Weinheim, 4^{th} edition 1992, pages 665 to 715.

A preferred polyurethane or polyisocyanurate rigid foam formulation for the purposes of this invention would result in a foam density of 20 to 150 kg/m³ and would have the composition mentioned in Table 1.

TABLE 1
Composition of a polyurethane or polyisocyanurate rigid foam formulation

| Component | Weight fraction |
|---|---|
| Polyol | 100 |
| amine catalyst | 0.05 to 5 |
| potassium trimerization catalyst | 0 to 10 |
| polyether siloxane | 0 to 5 |
| Water | 0.1 to 20 |
| blowing agent | 0 to 40 |
| flame retardant | 0 to 50 |
| inventive compound (of structure I) | 0.1 to 5 |
| isocyanate index: 80 to 500 | |

The inventive polyurethane foams (foamed polyurethane or polyisocyanurate materials) are marked in that they include at least one (inventive) compound containing at least one structural element of formula (I), as defined above, and are preferably obtainable by the process of the invention. Preferably, the inventive polyurethane or polyisocyanurate rigid foams contain, in bound and/or unbound form, from 0.1% to 10% by mass, preferably from 0.5% to 5% by mass and more preferably from 1% to 3% by mass of compounds including at least one structural element of formula (I).

The inventive PU foams (foamed polyurethane or polyisocyanurate materials) can be used as or for producing insulating materials, preferably insulating panels, refrigerators, insulating foams, vehicle seats, more particularly auto seats, roof liners, mattresses, filtering foams, packaging foams or spray foams.

Cooling apparatuses according to the present invention include by way of insulating material a PU foam (foamed polyurethane or polyisocyanurate material) according to the present invention.

The examples which follow describe the present invention by way of example without any intention to restrict the invention, the scope of which is apparent from the entire description and the claims, to the embodiments mentioned in the examples.

### EXAMPLES

### Example 1

### Preparing the Carbamates

### Example 1a

### Carbamate 1

Under nitrogen, 245g of soya oil and 26.4 g of diethanolamine were admixed with 0.3 g of sodium methoxide and stirred at 90° C. for 5 h. Then, 6.3 g of Polyvest® OC 800 S (addition product obtained from polybutadiene and maleic anhydride, available from Evonik Degussa) were added, followed by stirring at 80° C. for 1 h. Thereafter, a reaction product having an NCO content of 13.7%, prepared from 8.5 g of MDI (Desmodur® 44V20 available from Bayer) and 3.8 g of butyldiglycol using 0.03 g of Kosmos® 54 (a catalyst based on zinc ricinoleate, available from Evonik Goldschmidt) as catalyst, was added, which was again followed by stirring at 80° C. for 1 h, to obtain a clear yellowish product.

### Example 1b

### Carbamate 2

Under nitrogen, 246.8 g of soya oil and 36.7 g of diethanolamine were admixed with 0.3 g of sodium methoxide and stirred at 90° C. for 5 h. Then, 6.4 g of Polyvest® OC 800 S (addition product obtained from polybutadiene and maleic anhydride, available from Evonik Degussa) were added, followed by stirring at 80° C. for 1 h. Thereafter, 9.7 g of Vestanat® T 1890/100 (trimeric IPDI available from Evonik Degussa) were added, which was again followed by stirring at 80° C. for 1 h, to obtain a clear yellowish product.

### Example 1c

### Carbamate 3

Under nitrogen, 88.5 g of soya oil and 10.5 g of diethanolamine were admixed with 0.1 g of sodium methoxide and stirred at 90° C. for 5 h. Then, 2.25 g of Polyvest® OC 800 S (addition product obtained from polybutadiene and maleic anhydride, available from Evonik Degussa) were added, followed by stirring at 80° C. for 1 h. Thereafter, 2.97 g of Vestanat T 1890/100 (trimeric IPDI available from Evonik Degussa) were added, which was again followed by stirring at 80° C. for 1 h, to obtain a clear yellowish product.

### Example 1d

### Carbamate 4

Under nitrogen, 256.7 g of soya oil and 38.2 g of diethanolamine were admixed with 0.3 g of sodium methoxide and stirred at 90° C. for 5 h. Then, 1.6 g of ricinoleic acid were added, followed by stirring at 80° C. for 1 h. Thereafter, 3.2 g of TDI (isomeric mixtures of toluenyl diisocyanate available from Bayer as Desmodur® T 80) were added, which was again followed by stirring at 80° C. for 1 h to obtain a clear yellowish product.

### Example 1e

### Carbamate 5

Under nitrogen, 256g of soya oil and 38.1 g of diethanolamine were admixed with 0.3 g of sodium methoxide and stirred at 90° C. for 5 h. Then, 1.6 g of ricinoleic acid were added, followed by stirring at 80° C. for 1 h. Thereafter, 4.0 g of Vestanat® IPDI (isophorone diisocyanate available form Evonik Degussa) were added, which was again followed by stirring at 80° C. for 1 h to obtain a clear yellowish product.

### Example 1f

### Carbamate 6

Under nitrogen, 251.9 g of soya oil and 37.4 g of diethanolamine were admixed with 0.3 g of sodium methoxide and stirred at 90° C. for 5 h. Then, 1.6 g of ricinoleic acid were added, followed by stirring at 80° C. for 1 h. Thereafter, 8.7 g of Vestanat® T 1890/100 (trimeric IPDI available from Evonik Degussa) were added, which was again followed by stirring at 80° C. for 1 h to obtain a clear yellowish product.

### Example 1g

### Carbamate 7

Under nitrogen, 255 g of soya oil and 37.9 g of diethanolamine were admixed with 0.3 g of sodium methoxide and stirred at 90° C. for 5 h. Then, 1.6 g of ricinoleic acid were added, followed by stirring at 80° C. for 1 h. Thereafter, 5.2 g of Desmodur® VP PU 129 (monomeric MDI with enhanced 2,4-isomer fraction, available from Bayer) were added, which was again followed by stirring at 80° C. for 1 h to obtain a clear yellowish product.

### Example 1h

### Carbamate 8

Under nitrogen, 255 g of soya oil and 37.9 g of diethanolamine were admixed with 0.4 g of sodium methoxide and stirred at 90° C. for 5 h. Then, 1.6 g of ricinoleic acid were added, followed by stirring at 80° C. for 1 h. Thereafter, 5.2 g of Desmodur® CD-S (carbodiimide-modified MDI available from Bayer) were added, which was again followed by stirring at 80° C. for 1 h to obtain a clear yellowish product.

### Example 11

### Carbamate 9

Under nitrogen, 254.7 g of soya oil and 37.9 g of diethanolamine were admixed with 0.3 g of sodium methoxide and stirred at 90° C. for 5 h. Then, 1.6 g of ricinoleic acid were added, followed by stirring at 80° C. for 1 h. Thereafter, a reaction product having an NCO content of 13.7%, prepared from 3.8 g of MDI (Desmodur® 44V20 available from Bayer) and 1.7 g of butyldiglycol using 0.01 g of Kosmos® 54 (available from Evonik Goldschmidt) as catalyst, was added, which was again followed by stirring at 80° C. for 1 h, to obtain a clear yellowish product.

### Example 1j

### Carbamate 10

Under nitrogen, 235 g of soya oil and 42 g of diethanolamine were admixed with 0.6 g of sodium methoxide and stirred at 90° C. for 5 h. Then, 3.8 g of ricinoleic acid were added, followed by stirring at 80° C. for 1 h. Thereafter, a reaction product having an NCO content of 4.6%, prepared from 4.2 g of MDI (Desmodur® 44V20 available from Bayer) and 14 g of an allyl-started polyalkylene glycol (“Polyether F-6” from Jiangsu Zhongshan Chemicals) were added, which was again followed by stirring at 80° C. for 1 h, to obtain a clear yellowish product.

### Example 2

### Preparation of Siloxane Compounds

### Example 2a

### Siloxane 1

Siloxane 1 is a polyether siloxane prepared as described in Example 14 of EP 1544235 A1.

### Example 2b

### Siloxane 2

Siloxane 2 is a polydimethylsiloxane prepared as mixture 1 in Example 4 of DE 2533074 A1.

### Example 2c

### Siloxane 3

Siloxane 3 is a polyether siloxane as described in EP 1544235 A1 where x=70, y=4, and two polyethers with 37 val % of polyether 1 (a=36, b=38 and R″=methyl) and 63 val % of polyether 2 (a=12, b=0 and R″′=methyl). Siloxane 3 is accordingly a polyether siloxane as per the following formula:

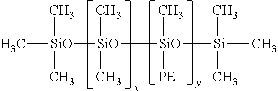

where, y=4, x=70, PE is polyether or to be more precise here a mixture of two polyethers: 37.5 val % of a methylated polyether with Mn=3800 g/mol, prepared from 58% by weight of propylene oxide and 42% by weight of ethylene oxide, and 62.5 val % of a methylated polyether with Mn=600 g/mol, prepared from 100% by weight of ethylene oxide. The preparation of such Si—C-linked polyether siloxanes is described in U.S. Pat. No. 4,147,847, EP 0493836 and U.S. Pat. No. 4,855,379 for example.

The disclosure content of EP-1544325 and of DE-2533074 is hereby fully incorporated in this description by reference.

### Example 3

### Preparation of Admixtures of Inventive Compounds or Non-Inventive Compounds with Si-Containing Compounds

Foam types where the inventive compounds on their own did not provide sufficiently good foam quality were catered for by preparing appropriate admixtures with Si-containing compounds. Admixtures with the prior art admix components were also prepared, for comparative tests. The admixtures were prepared by simply adding the components together and then stirring for 5 minutes.

The comparative examples utilized the following substances as typical representatives of non-inventive compounds:
A) nonylphenol+8E0: reaction product of nonylphenol with 8 mol of ethylene oxide per OH function, commercially available, for example as Arkopal® N 080 from Clariant.
B) castor oil, commercially available, for example from Alberding+Boley, Krefeld.
C) PEG 400 dioleate, commercially available, for example as MARLOWET® 4702 from Sasol.
D) diisononyl phthalate, commercially available, for example as Jayflex® DINP from Exxon.
E) Rewomid® DC 212 S oleic acid diethanolamide (from Evonik Goldschmidt).

The compositions of the admixtures are reported in Table 2.

TABLE 2
Admixtures of organosiloxanes with carbamates

| Example | Organosiloxane | Admixed component |
|---|---|---|
| 3a | siloxane 1, 50 parts | carbamate 3, 50 parts |
| 3b | siloxane 1, 50 parts | carbamate 4, 50 parts |
| 3c | siloxane 1, 50 parts | carbamate 5, 50 parts |
| 3d | siloxane 1, 50 parts | carbamate 7, 50 parts |
| 3e | siloxane 1, 50 parts | carbamate 8, 50 parts |
| 3f | siloxane 1, 50 parts | carbamate 2, 50 parts |
| 3g | siloxane 1, 50 parts | carbamate 6, 50 parts |
| 3h | siloxane 1, 50 parts | carbamate 10, 50 parts |
| 3V1 | siloxane 1, 50 parts | A), 50 parts |
| 3V2 | siloxane 1, 50 parts | B), 50 parts |
| 3V3 | siloxane 1, 50 parts | C), 50 parts |
| 3V4 | siloxane 1, 50 parts | E), 50 parts |
| 3i | siloxane 2, 10 parts | carbamate 3, 90 parts |
| 3j | siloxane 2, 10 parts | carbamate 1, 90 parts |
| 3k | siloxane 2, 10 parts | carbamate 9, 90 parts |
| 3l | siloxane 2, 10 parts | carbamate 5, 90 parts |
| 3m | siloxane 2, 10 parts | carbamate 2, 90 parts |
| 3n | siloxane 2, 10 parts | carbamate 7, 90 parts |
| 3o | siloxane 2, 10 parts | carbamate 8, 90 parts |
| 3V5 | siloxane 2, 10 parts | D), 90 parts, |
| 3V6 | siloxane 2, 10 parts | E), 90 parts*) |
| 3p | siloxane 3, 65 parts | carbamate 4, 35 parts |
| 3q | siloxane 3, 65 parts | carbamate 5, 35 parts |
| 3r | siloxane 3, 65 parts | carbamate 2, 35 parts |
| 3s | siloxane 3, 65 parts | carbamate 9, 35 parts |
| 3t | siloxane 3, 65 parts | carbamate 1, 35 parts |
| 3u | siloxane 3, 65 parts | carbamate 3, 35 parts |
| 3V7 | siloxane 3, 65 parts | A), 35 parts |

*The mixture was not clear, which can be explained by the improved solution properties of carbamates versus diethanolamides.

### Example 4

### Use Examples in Foaming

The performance advantages over the prior art which are provided by using the inventive compounds in polyurethane foams will now be demonstrated by means of use examples.

The foamings were carried out by a manual mixing method. For this purpose, polyol, flame retardants, catalysts, water, a conventional or inventive foam stabilizer, as the case may be, and blowing agents were weighed into a beaker and mixed together using a plate stirrer (6 cm in diameter) at 1000 rpm for 30 s. The blowing agent quantity evaporated during mixing was determined by renewed weighing and replenished. Then, the isocyanate (MDI) was added, the reaction mixture was stirred with the described stirrer at 3000 rpm for 5 s and either foamed up in the beaker itself, in the case of the pour-in-place foaming, or, in the case of the other foamings, immediately transferred to a thermostatted aluminium mold lined with polyethylene film. Mold temperature and geometry varied with the foam formulation. The use quantity of foam formulation was determined such that it was 15% above the minimum amount needed to fill the mold.

One day after the foaming operation, the foamed materials were analyzed. In the case of the beaker foams, the rise behaviour, i.e., the outer shape, the surface of the foam and also, by means of a cut surface in the upper part of the foam, the degree of internal disruptions and the pore structure were visually assessed on a scale from 1 to 10, where 10 represents an undisrupted foam and 1 represents an extremely disrupted foam. In the case of the mold foams, surface and internal disruptions were likewise assessed subjectively on a scale from 1 to 10. The pore structure (average number of cells per cm) was assessed visually on a cut surface by comparison against comparative foams. The thermal conductivity coefficient (λ value) was measured on discs 2.5 cm in thickness using an instrument of the Hesto Lambda Control type at temperatures of 10° C. and 36° C. on the sample bottom face and top face. The percentage volume fraction of closed cells was determined using an AccuPyc 1330 type instrument from Micromeritics. The compression hardnesses of the foamed materials were measured on cube-shaped sample specimens of 5 cm edge length according to DIN 53421 up to a compression of 10% (the value reported is the maximum compressive stress arising in this measuring range).

### Example 4a

### Rigid Foam, Pour-in-Place Formulation with Inventive Compound Only as Foam Stabilizer

The PUR rigid foam system specified in Table 3 was used for the pour-in-place applications.

TABLE 3
pour-in-place formulation

| Component | Weight fraction |
|---|---|
| Voranol RN 490* | 70 parts |
| Terate 203** | 20 parts |
| Stepanpol PS 3152*** | 10 parts |
| tris(1-chloro-2-propyl) phosphate | 6 parts |
| N,N-dimethylethanolamine | 0.35 part |
| N,N-dimethylcyclohexylamine | 1.6 parts |
| Kosmos 19 | 0.07 |
| Water | 0.33 part |
| foam stabilizer | 1.3 part |
| Cyclopentane | 21 parts |
| Desmodur 44V20L**** | 151 parts |

*polyether polyol from Dow
**polyester polyol from Invista
***polyester polyol from Stepan
****polymeric MDI from Bayer; 200 mPa * s; 31.5% NCO; functionality = 2.7

The results of the pour-in-place applications are reported in Table 4.

TABLE 4
Pour-in-place results

| | Stabilizer | Defects internal | Pore structure | Rise | |
|---|---|---|---|---|---|
| Ex. | of Ex. | (1-10) | (1-10) | behaviour | Surface |
| 4a1* | 3 A) | 4 | 3 | 5 | 3 |
| 4a2* | 3 C) | 4 | 3 | 5 | 3 |
| 4a3* | 3 E) | 5 | 3 | 4 | 5 |
| 4a4 | 1b | 6 | 5 | 5 | 5 |
| 4a5 | 1c | 6 | 6 | 5 | 5 |
| 4a6 | 1j | 8 | 7 | 6 | 7 |

*non-inventive comparative examples

Examples 4a4 to 4a6 show that the inventive compositions provided PU foams and that the foam qualities obtained are better than obtained with the known compositions, which utilize fatty acid amides (Example 4a3).

### Example 4b

### PUR Rigid Foam System for Insulation of Refrigerators

A formulation optimized to this application was used (see Table 5) and foamed up either with inventive foam stabilizers or with non-inventive foam stabilizers. The reaction mixture was introduced into an aluminium mould 145 cm×14.5 cm×3.5 cm in size and thermostatted to 45° C.

TABLE 5
Fridge insulation formulation

| Component | Parts by weight |
|---|---|
| Daltolac R 471* | 100 parts |
| N,N-dimethylcyclohexylamine | 1.5 parts |
| water | 2.6 parts |
| cyclopentane | 13.1 parts |
| stabilizer | 1.5 parts |
| Desmodur 44V20L** | 198.5 parts |

*polyetherpolyol from Huntsman
**polymeric MDI from Bayer; 200 mPa * s; 31.5% NCO; functionality 2.7

The results shown in Table 6 reveal that the inventive stabilizers all without exception provide lower thermal conductivities than the non-inventive, comparative stabilizers, which do not contain any inventive compounds (carbamates). The inventive stabilizers also provide a better surface quality to the foams.

TABLE 6
Fridge insulation results

| | Stabilizer of | Defects (1-10) | | λ value/ |
|---|---|---|---|---|
| Ex. | Ex. | top/bottom/internal | Cells/cm⁻¹ | mW/m * K |
| 4b1 | 3V4 | 5/5/5 | 35-39 | 22.6 |
| 4b2 | 3V1 | 5/4/5 | 35-39 | 22.6 |
| 4b3 | 3V2 | 5/4/4 | 35-39 | 22.8 |
| 4b4 | 3V3 | 5/4/5 | 35-39 | 22.7 |
| 4b5 | 3b | 7/3/6 | 40-44 | 22.2 |
| 4b6 | 3c | 7/3/6 | 40-44 | 22.2 |
| 4b7 | 3d | 6/4/6 | 40-44 | 22.4 |
| 4b8 | 3e | 7/4/6 | 40-44 | 22.2 |
| 4b9 | 3f | 7/5/6 | 40-44 | 22.3 |
| 4b10 | 3a | 7/5/6 | 40-44 | 22.0 |
| 4b11 | 3g | 7/4/6 | 40-44 | 22.2 |
| 4b12 | 3h | 7/5/6 | 40-44 | 22.1 |

*non-inventive, comparative examples using oleic acid diethanolamide and NP8 as admixed component to the siloxane

### Example 4c

### HR Foam (High-Resilience Foam, Cold-Cure Foam)

The stabilizers used were either mixtures of silicon compounds and inventive compound as per Table 2 or inventive compounds alone or, as comparative substance, oleic acid diethanolamide (3E).

The following formulation was used: 100 parts of polyol having an OH number of 35 mg KOH/g and a molar mass of 5000 g/mol, 0.4 part or 1.2 parts of stabilizer, 3 parts of water, 2 parts of triethanolamine, 0.6 part of TEGOAMIN® 33 (from Evonik Goldschmidt GmbH) and 0.2 part of diethanolamine and a mixture of 18.5 parts of polymeric MDI (44V20 from Bayer) and 27.7 parts of TDI (Desmodur® T 80 from Bayer).

The foams were prepared in the known manner by mixing all the components except for the isocyanate in a beaker, then adding the isocyanate and stirring it in rapidly at high stirrer speed. Next, the reaction mixture was introduced into a cuboid mold having the dimensions 40×40×10 cm, which had been heated to a temperature of 40° C., and the mass was allowed to cure for 10 minutes. Subsequently, the compressive forces were measured. For this, the foams were compressed 10 times to 50% of their height. The 1^{st} measured value (AD 1 in newtons) is a measure of the open-cell character of the foam. Then, compression was effected completely (manually) in order to be able to determine the hardness of the compressed foam at the 11^{th} measured value (AD 11 in newtons). Thereafter, the foams were cut open in order to assess the skin and the edge zone and to determine the cell count (ZZ in cm⁻¹).

Table 7 which follows summarizes the respective proportions of stabilizer and also the results of the testing.

TABLE 7
Results for Examples 4c (high-resilience foam)

| | | | | | | Proportion of stabilizer |
|---|---|---|---|---|---|---|
| Ex. | AD 1 | AD 11 | ZZ | Skin | Edge zone | as per Ex. |
| 4c1 | 1118 | 124 | 10 | good | good | 0.4 pphp of 3i |
| 4c2 | 1070 | 120 | 10 | good | good | 0.4 pphp of 3j |
| 4c3 | 1077 | 123 | 10 | good | good | 0.4 pphp of 3k |
| 4c4 | 1126 | 122 | 10 | good | good | 0.4 pphp of 3l |
| 4c5 | 1039 | 123 | 10 | good | good | 0.4 pphp of 3m |
| 4c6 | 1081 | 126 | 10 | good | good | 0.4 pphp of 3n |
| 4c7 | 1007 | 123 | 10 | good | good | 0.4 pphp of 3o |
| 4c8 | 1061 | 124 | 10 | good | good | 0.4 pphp of 3V5 |
| 4c9 | 937 | 127 | 10 | good | satisfactory | 1.2 pphp of 1c |
| 4c10 | 858 | 126 | 10 | good | adequate | 1.2 pphp of 1h |
| 4c11 | 954 | 131 | 10 | good | inadequate | 1.2 pphp of 3 E) |

The results show that the inventive compounds lead to good results in HR foaming in combination with silicon compounds. Since the oleic acid diethanolamide 3 E) did not produce a clear mixture with siloxane 2 (Example 3V6), no foaming test was carried out with it.

It was also shown that the inventive compounds can also be used as Si-free foam additives. Better results were obtained in this compared with the oleic acid diethanolamide 3 E).

### Example 4d

### Foamings in Hot-Cure Flexible Foam

The compositions investigated represent typical polyurethane hot-cure flexible foam formulations. The compositions contained: 100 parts by weight of polyol (Desmophen® PU20WB01 from Bayer, OH number 56), 5.0 parts by weight of water (chemical blowing agent), 1.0 part by weight of stabilizer as described in Table 2, 0.15 part by weight of amine catalyst (triethylenediamine), 0.23 part by weight of tin catalyst (tin 2-ethylhexanoate), 5.0 parts by weight of methylene chloride (additional physical blowing agent) and 63.04 parts by weight of isocyanate (tolylene diisocyanate, Desmodur® T 80 from Bayer) (ratio of isocyanate groups to isocyanate-consuming reactive groups=1.15).

Polyol, water, catalysts and stabilizer were initially charged to a paper cup and commixed using a stiffing disc (45 s at 1000 rpm). Then, the methylene chloride was added followed by mixing at 1000 rpm for another 10 s. Next, the isocyanate (T80) was added again followed by stirring at 2500 rpm for 7 s. The mixture was then introduced into a mould open at the top and measuring 30 cm×30 cm×30 cm. The height of rise during foaming was then determined using an ultrasonic height measurement. The rise time is the time which elapses until the foam has reached its maximum height of rise. The fall-back is the term used to describe the sagging of the foam surface after the blowing off of the polyurethane hot-cure flexible foam. The fall-back was measured 3 min after the blowing off. The foam density was measured according to DIN EN ISO 845 and DIN EN ISO 823. The cell count was done at three places using an eyeglass with a scale, and the values were averaged. Compression hardness was measured to DIN EN ISO 3386-1 and the SAG factor was computed from the quotient formed from compression hardness at 65% compression and 25% compression of the foam. Thus, the SAG factor is a measure of the resilience of the foam.

Table 8 shows the results of the polyurethane hot-cure flexible foam production process. It reports the stabilizer used, the rise time (SZ) in seconds, the foam height (SH) in cm, the fall-back (RF) in cm, the foam density (RG) in kg/m³ and the cell count (ZZ) in cells/cm and the SAG factor (SAG-F).

TABLE 8
Results of polyurethane hot-cure flexible foam production

| | | | | | RG/ | ZZ/ | |
|---|---|---|---|---|---|---|---|
| Ex. | Stabilizer | SZ/s | SH/cm | RF/cm | (kg/m³) | cm⁻¹ | SAG-F |
| 4d1 | 3p | 87 | 35 | 0.5 | 17.0 | 6 | 2.3 |
| 4d2 | 3q | 87 | 35.2 | 0.4 | 16.9 | 6 | 2.2 |
| 4d3 | 3r | 87 | 35.3 | 0.6 | 16.8 | 6 | 2.2 |
| 4d5 | 3s | 87 | 35.5 | 0.8 | 17.0 | 6 | 2.3 |
| 4d6 | 3t | 85 | 32.5 | 0.5 | 17.0 | 6 | 2.1 |
| 4d7 | 3u | 86 | 35.7 | 0.4 | 17.0 | 6 | 2.2 |
| 4d8 | 3V7 | 86 | 35.2 | 0.4 | 17.2 | 6 | 2.4 |

The results show that the inventive compositions are suitable for producing hot-cure flexible foam and do not lead to any disadvantages whatsoever in respect of the physical properties of the foams.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A composition for producing polyurethane foams, said composition comprising at least a polyol component, a catalyst catalyzing formation of a urethane or isocyanurate bond, and a compound containing at least one structural element of formula (I) 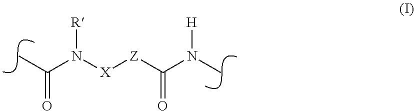
where R′ in each occurrence is the same or different and represents H or an organic radical,
X in each occurrence is the same or different and represents an organic radical having at least two carbon atoms, and
Z in each occurrence is the same or different and represents O or NR″′ where R″′ is H or alkyl.

2. The composition according to claim 1, wherein said compound containing at least one structural element of formula (I) is a compound of formula (III) 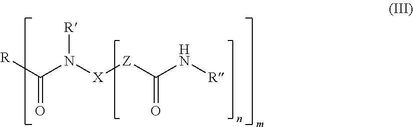
where X, Z and R′ are each as defined in claim 1 and R″ in each occurrence is the same or different and represents an organic radical, n=1 to 5, m=1 to 5 and R is an organic radical.

3. The composition according to claim 1, wherein said compound containing at least one structural element of formula (I) is a compound of formula (IV) 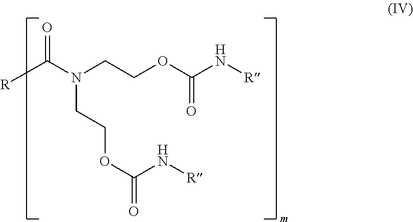
or of formula (IVa) 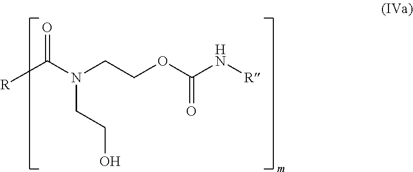
or of formula (IVb) 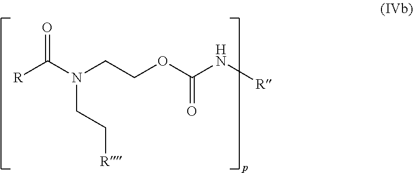
where m is 1 to 5, R is an organic radical, R″ in each occurrence is the same or different and represents an organic radical, R″″ is —OH or —OC(O)—NH—R″ and p=1 to 10.

4. The composition according to claim 1, wherein said compound containing at least one structural element of formula (I) is present in a proportion of from 0.1 to 10 parts by mass, based on 100 parts by mass of polyol components.

5. The composition according to claim 1, further comprising one or more silicon compounds selected from the group consisting of polysiloxanes, organomodified polysiloxanes, polyether-modified polysiloxanes and polyether-polysiloxane copolymers.

6. The composition according to claim 5, wherein a mass ratio of said one or more silicon compounds to said compound containing at least one structural element of formula (I) is in a range from 0.01:1 to 1:0.01.

7. The composition according to claim 1, wherein the composition includes from 0.05 to 10 parts by mass of said polyol component per 100 parts by mass.

8. A process for producing foamed polyurethane or polyisocyanurate materials comprising reacting a composition comprising at least a polyol component, a catalyst catalyzing formation of a urethane or isocyanurate bond, and a compound containing at least one structural element of formula (I) 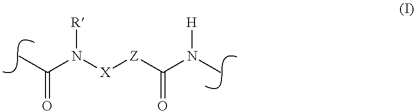
where R′ in each occurrence is the same or different and represents H or an organic radical,
X in each occurrence is the same or different and represents an organic radical having at least two carbon atoms, and
Z in each occurrence is the same or different and represents O or NR″′ where R″′ is H or alkyl.

9. A polyurethane foam containing at least one compound which includes at least one structural element of formula (I) 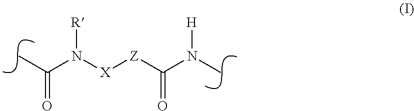
where R′ in each occurrence is the same or different and represents H or an organic radical,
X in each occurrence is the same or different and represents an organic radical having at least two carbon atoms, and
Z in each occurrence is the same or different and represents O or NR″′ where R″′ is H or alkyl.

10. An article comprising a polyurethane foam according to claim 9.

11. The article of claim 10, wherein said polyurethane foam is an insulating material.
